(19) United States
(12) Patent Application Publication
(10) Pub. No.: US 2024/0303181 A1
(43) Pub. Date: Sep. 12, 2024

(54) HIGH-ACCURACY LOG SUPERVISION METHOD AND SYSTEM

(71) Applicant: Moremo Network Limited, Shenzhen (CN)

(72) Inventor: Yaobin LIU, Shenzhen (CN)

(73) Assignee: Moremo Network Limited, Shenzhen (CN)

(21) Appl. No.: 18/666,378

(22) Filed: May 16, 2024

(30) Foreign Application Priority Data
Oct. 16, 2023 (CN) 202311337524.5

(51) Int. Cl. G06F 11/36

(52) U.S. Cl. CPC G06F 11/366

(57) ABSTRACT

The present disclosure provides a log supervision method and a system. The method includes: acquiring, by a mobile terminal, a log generated by an application; adding, by the mobile terminal, a device id, a startup id and an event id to the log to obtain a standardized log, where the device id is used for uniquely identifying the mobile terminal, the startup id is used for identifying a number of times of startup of the application after the application is installed, and the event id is used for identifying a number of times of event occurrence of the application after the application is installed; sending, by the mobile terminal, the standardized log to a server; summarizing, by the server, all standardized logs from different mobile terminals, and determining whether the standardized logs are incorrect.

### CROSS-REFERENCE TO RELATED APPLICATION

This application claims priority to Chinese Patent Application No. 202311337524.5, filed on Oct. 16, 2023, which is hereby incorporated by reference in its entirety.

### TECHNICAL FIELD

The present disclosure belongs to the technical field of software programs, and specifically relates to a high-accuracy log supervision method and a system.

### BACKGROUND

Logs generated during running processes of mobile applications are very important. These logs need to be transmitted by the mobile applications to a server through a network, and analyzed by the server. However, at present, there may still be errors in the logs received by the server, and the reasons are as follows.
1. There are mainly two kinds of networks used by the mobile applications, namely, WIFI and mobile traffic. Neither of the two kinds of networks is a fixed network, and network problems may often be caused due to various situations. For example, the two kinds of networks may be affected by location change/signal change/network switching/bandwidth occupation/channel occupation of other devices.
2. When a logic of program codes in the mobile client and the server has an error, it will also lead to an error in the logs received by the server. For example, the logs received by the server have the following defects: (1) log missing: only two of three logs are received; (2) log repetition: there are three logs but four logs are received; (3) log disorder: for logs 1, 2 and 3, the server receives logs 1, 3 and 2 as a result.

When the logs received by the server have the foregoing problems, it can only be checked and found manually, which is very non-intuitive and also very time-consuming.

### SUMMARY

In view of the defects in the prior art, the present disclosure provides a high-accuracy log supervision method and a system, which can automatically detect whether a received log is correct, improving the accuracy of log management.

In a first aspect, a high-accuracy log supervision method includes:
acquiring, by a mobile terminal, a log generated by an application;
adding, by the mobile terminal, a device id, a startup id and an event id to the log to obtain a standardized log; where the device id is used for uniquely identifying the mobile terminal; the startup id is used for identifying a number of times of startup of the application after the application is installed; the event id is used for identifying a number of times of event occurrence of the application after the application is installed;
sending, by the mobile terminal, the standardized log to a server;
summarizing, by the server, all standardized logs from different mobile terminals, and determining, by the server, whether the standardized logs are incorrect.

Further, the device id is obtained by performing a Hash operation on a mobile terminal id of the mobile terminal.

Further, the startup id includes the device id and a first character string; every time the application is started, the first character string is increased by 1; the first character string is initialized to 1, and is set to 1 after overflow.

Further, the event id includes the startup id, a second character string and a begin-end flag; every time an event of the application occurs, the second character string is increased by 1; the second character string is initialized to 1, and is set to 1 after overflow; the begin-end flag is used for identifying a beginning event, an intermediate event or an end event.

Further, determining, by the server, whether the standardized logs are incorrect specifically includes:
recording, by the server, a previous-event id of each device id;
sorting, by the server, all standardized logs in an order of an occurrence time from small to large and the event id from small to large, and grouping, by the server, all standardized logs according to the device id;
traversing, by the server, each group, and determining, by the server, whether standardized logs in each group are incorrect.

Further, determining, by the server, whether the standardized logs in each group are incorrect specifically includes:
acquiring the device id, the startup id and the event id of each standardized log in the group;
when the device id, the startup id or the event id is invalid, determining that the standardized log is incorrect;
when the device id, the startup id and the event id are valid, calculating a range of a next-event id according to the previous-event id of the device id;
when the event id is within the range of the next-event id, determining that the standardized log is correct, and setting a present-event id as the previous-event id of the device id;
when the event id is not within the range of the next-event id, determining that the standardized log is incorrect.

Further, calculating the range of the next-event id according to the previous-event id of the device id specifically includes:
when the previous-event id of the device id does not exist, the first character string and the second character string of the event id are 1 and the begin-end flag identifies the beginning event in the range of the next-event id;
when the previous-event id of the device id is the beginning event or the intermediate event, the range of the next-event id includes two event ids, and second character strings of the two event ids are both increased by 1, where the begin-end flag of one event id identifies the intermediate event, and the begin-end flag of the other event id identifies the end event;
when the previous-event id of the device id is the end event, the first character string and the second character string of the event id are both increased by 1 and the begin-end flag identifies the beginning event in the range of the next-event id.

Further, after determining that the standardized log is incorrect, the method further includes:
determining an error category of the standardized log; where, the error category is a first-time event missing when the previous-event id of the device id does not exist;
the error category is an event repetition when the previous-event id of the device id is equal to the present-event id;
the error category is an event disorder when the previous-event id of the device id is greater than the present-event id;
the error category is an event missing when the previous-event id of the device id is smaller than the present-event id.

Further, the method further includes:
when receiving a filtering instruction including the device id or the startup id, obtaining, by the server, logs related to the application by filtering according to the device id, or obtaining, by the server, logs related to one startup of the application by filtering according to the startup id.

In a second aspect, a high-accuracy log supervision system includes a mobile terminal and a server;
where the mobile terminal is configured to: acquire a log generated by an application, and add a device id, a startup id and an event id to the log so as to obtain a standardized log, where the device id is used for uniquely identifying the mobile terminal, the startup id is used for identifying a number of times of startup of the application after the application is installed, and the event id is used for identifying a number of times of event occurrence of the application after the application is installed; and send the standardized log to the server;
the server is configured to summarize all standardized logs from different mobile terminals and determine whether the standardized logs are incorrect.

It can be understood from the above technical solutions that in the log supervision method and system provided by the present disclosure, the device id, the event id and the startup id are added to the log, so that the log is orderly. If the server receives a log with an incorrect order, it can also be determined which mobile terminals, which startup or which event has a problem. The log supervision method is not related to specific applications and can be used by all applications, and thus has high universality. The log supervision method can be programmed, and can automatically detect whether a received log is correct, improving the accuracy of log management.

### BRIEF DESCRIPTION OF DRAWINGS

To describe technical solutions in embodiments of the present disclosure or in the prior art more clearly, the following briefly introduces the accompanying drawings required for describing the embodiments or the prior art. In all accompanying drawings, similar elements or portions are generally identified by similar reference signs. In the accompanying drawings, each element or portion may not necessarily be drawn to the actual scale.

FIG. 1 is a flowchart of a log supervision method provided by an embodiment.

FIG. 2 is a flowchart of a determination method for a standardized log provided by an embodiment.

### DESCRIPTION OF EMBODIMENTS

Hereinafter, embodiments of technical solutions of the present disclosure will be described in detail with reference to the accompanying drawings. The following embodiments are only used to illustrate the technical solutions of the present disclosure more clearly, and therefore are only used as examples and cannot be used to limit the scope of protection of the present disclosure. It should be noted that unless otherwise specified, technical terms or scientific terms used in the present application should have a common meaning understood by those skilled in the art to which the present disclosure belongs.

It should be understood that the terms “comprise” and “include”, when used in the present specification and the appended claims, indicate the presence of described features, entireties, steps, operations, elements and/or components, but do not exclude the presence or addition of one or more other features, entireties, steps, operations, elements, components and/or collections thereof.

It should also be understood that the terms used in the specification of the present disclosure herein are for the purpose of describing specific embodiments only and not intended to limit the present disclosure. As used in the specification of the present disclosure and the appended claims, singular forms of “a”, “an” and “the” are intended to include plural forms, unless the context clearly indicates otherwise.

As used in the present specification and the appended claims, the term “if” may be interpreted, depending on the context, as “when” or “once” or “in response to determination” or “in response to detection”. Similarly, the phrase “if it is determined” or “if [the described condition or event] is detected” may be interpreted, depending on the context, as meaning “once it is determined” or “in response to determination” or “once [the described condition or event] is detected” or “in response to the detection of [the described condition or event]”.

### EMBODIMENTS

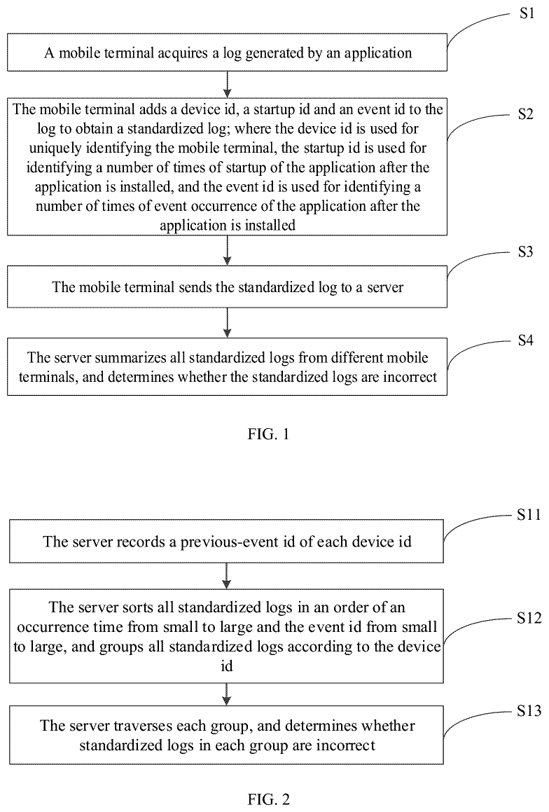

Referring to FIG. 1, a high-accuracy log supervision method includes:
S1: a mobile terminal acquires a log generated by an application;
S2: the mobile terminal adds a device id (identity), a startup id and an event id to the log to obtain a standardized log; where the device id is used for uniquely identifying the mobile terminal, the startup id is used for identifying a number of times of startup of the application after the application is installed, and the event id is used for identifying a number of times of event occurrence of the application after the application is installed;
S3: the mobile terminal sends the standardized log to a server;
S4: the server summarizes all standardized logs from different mobile terminals, and determines whether the standardized logs are incorrect.

In this embodiment, the log of the application is generally structured data. For example, the log contains the following information: an occurrence time: recording an accurate time when an event occurs; an event name: recording the type of the event, such as an error, a warning or information; detailed information: recording other specific details that need to be clarified, such as an error code, abnormal information, etc. In the method, the mobile terminal adds the device id, the startup id and the event id to the log to obtain the standardized log.

With regard to the device id, the device id is used for uniquely identifying the mobile terminal, and device ids of different mobile terminals are different. The device id may be a hexadecimal character string containing digits of 0-9 and letters of a-f, and the length is fixed to 32 bits. The device id may be obtained by performing a Hash operation on a mobile terminal id of the mobile terminal. For an IOS system and an Android system, the mobile terminal id may be obtained through an API application program interface. The mobile terminal id relates to user privacy, and cannot be directly transmitted to the server. By means of md5 (Message-Digest Algorithm 5) Hash, the method can ensure that the server cannot obtain source information, ensuring the security of user privacy. The range of the mobile terminal id is large enough, and an attacker cannot crack and obtain it by credential stuffing. For example, the device id is: 3a55d95595a6f9e37dee53826b4daff2.

With regard to the startup id, the startup id is used for identifying the number of times of startup of the application after the application is installed, and the startup id corresponding to each startup of each application in each mobile terminal is unique. The startup id includes the device id and a first character string. For example, the format of the startup id is set as: device id-first character string. The first character string may be fixed to 8 bits, with the first several bits thereof being padded with 0. For example, 00000001 indicates startup for the first time, and every time the application is started, the first character string is increased by 1. The first character string supports 99999999 times of startup at most, and if 99999999 times is exceeded, the first character string overflows and is reset to 00000001. For example, a startup id is 3a55d95595a6f9e37dee53826b4daff2-00000008. The startup id contains the device id, which redundantly saves information in order to perform data check and prevent errors.

With regard to the event id, the event id is used for identifying the number of times of event occurrence of the application after the application is installed, and the event id corresponding to each event occurrence of each application in each mobile terminal is unique. The event id includes the startup id, a second character string and a begin-end flag. The format of the event id may be set as: startup id-second character string [−bl-e]. The second character string may be fixed to 10 bits, with the first several bits thereof being padded with 0. For example, 0000000001 indicates the first event. When one event of the application occurs, the second character string is increased by 1. The second character string supports 9999999999 times of events at most, and if 9999999999 times is exceeded, the second character string overflows and is reset to 0000000001. The begin-end flag may be expressed as: [−bl-e], where −b indicates a beginning event (begin) for one startup, −e indicates an end event (end) for one startup, and none indicates an intermediate event. For example, an event id of a beginning event is: 3a55d95595a6f9e37dee53826b4daff2-00000008-0000000231-b; an event id of an intermediate event is: 3a55d95595a6f9e37dee53826b4daff2-00000008-0000000231; and an event id of an end event is: 3a55d95595a6f9e37dee53826b4daff2-00000008-0000000231-e. The event id contains the startup id and the device id, which redundantly saves information in order to perform data check and prevent errors.

For example, the obtained standardized log contains the following information: the device id: 3a55d95595a6f9e37dee53826b4daff2; the startup id: 3a55d95595a6f9e37dee53826b4daff2-00000008; the event id: 3a55d95595a6f9e37dee53826b4daff2-00000008-0000000231; the occurrence time: recording the accurate time when an event occurs; the event name: recording the type of the event, such as an error, a warning or information; the detailed information: recording other specific details that need to be clarified, such as an error code, abnormal information, etc.

In this embodiment, the server summarizes all standardized logs from different mobile terminals, and determines whether each standardized log is incorrect. For example, the server or the mobile terminal may summarize the standardized logs in a form of a table, such as the following table, * * * in the following table indicates that the middle part of the device id is omitted:

| Device | | | Occurrence | | Detailed |
|---|---|---|---|---|---|
| id | Startup id | Event id | time | Event name | information |
| 3a***f2 | 3a***f2- | 3a***f2- | Aug. 15, 2023 | Program | Begin to start |
| | 00000001 | 00000001- | 16:39:28.032 | startup | program, entering |
| | | 0000000001-b | | | initialization state . . . |
| 3a***f2 | 3a***f2- | 3a***f2- | Aug. 15, 2023 | Library | Begin to initialize |
| | 00000001 | 00000001- | 16:39:29.162 | initialization | dependency library: |
| | | 0000000002 | | | network library . . . |
| 3a***f2 | 3a***f2- | 3a***f2- | Aug. 15, 2023 | Library | Begin to clean up |
| | 00000001 | 00000001- | 16:48:19.624 | cleanup | dependency library: |
| | | 0000000132 | | | network library . . . |
| 3a***f2 | 3a***f2- | 3a***f2- | Aug. 15, 2023 | Program end | Cleanup is |
| | 00000001 | 00000001- | 16:48:20.003 | | completed, and |
| | | 0000000133-e | | | program ends . . . |
| 3a***f2 | 3a***f2- | 3a***f2- | Aug. 15, 2023 | Program | Begin to start |
| | 00000002 | 00000002- | 17:02:07.313 | startup | program, entering |
| | | 0000000134-b | | | initialization state . . . |
| 3a***f2 | 3a***f2- | 3a***f2- | Aug. 15, 2023 | Library | Begin to initialize |
| | 00000002 | 00000002- | 17:02:08.662 | initialization | dependency library: |
| | | 0000000135 | | | network library . . . |
| 3a***f2 | 3a***f2- | 3a***f2- | Aug. 15, 2023 | Library | Begin to clean up |
| | 00000002 | 00000002- | 17:11:05.600 | cleanup | dependency library: |
| | | 0000000283 | | | network library . . . |
| 3a***f2 | 3a***f2- | 3a***f2- | Aug. 15, 2023 | Program end | Cleanup is |
| | 00000002 | 00000002- | 17:11:07.492 | | completed, and |
| | | 0000000284-e | | | program ends . . . |

In the log supervision method, the device id, the event id and the startup id are added to the log, so that the log is orderly. If the server receives a log with an incorrect order, it can also be determined which mobile terminals, which startup or which event has a problem. The log supervision method is not related to specific applications and can be used by all applications, and thus has high universality. The log supervision method can be programmed, and can automatically detect whether a received log is correct, improving the accuracy of log management.

Further, in some embodiments, referring to FIG. 2, determining by the server of whether the standardized logs are incorrect specifically includes:
S111: the server records a previous-event id of each device id;
S512: the server sorts all standardized logs in an order of an occurrence time from small to large and the event id from small to large, and groups all standardized logs according to the device id;
S13: the server traverses each group, and determines whether standardized logs in each group are incorrect.

In this embodiment, the standardized log has the following characteristics. (1) Orderliness. If standardized logs of the same mobile terminal are sorted according to the occurrence time, the startup ids and the event ids are strictly sorted in the order from small to large. For example, if the startup id of a previous standardized log is 3a***f2-00000001, the startup id of a next standardized log can only be 3a***f2-00000001 or 3a***f2-00000002. A next log of the beginning event/intermediate event must be the intermediate event/end event. For example, when the event id of a standardized log is 3a***f2-00000001-0000000134-b or 3a***f2-00000001-0000000134, the event id of a next log can only be 3a***f2-00000001-0000000135 or 3a***f2-00000001-0000000135-e. A next log of the end event must be the beginning event. For example, when the event id of a log is 3a***f2-00000001-0000000134-e, the event id of a next log can only be 3a***f2-00000002-0000000135-b. (2) Redundancy. The startup id contains the device id, and the event id contains the startup id and the device id, which are used for determine whether a single log has an error. (3) Intuitiveness, for determining and finding out whether a plurality of logs have errors. For example, the device id, the startup id and the event id are character strings of fixed length and continuous values. If the device id or the startup id is selected and highlighted and the −b/−e mark is combined, errors in the plurality of logs can be determined.

In this embodiment, based on three characteristics of the standardized log, the server can simultaneously detect a plurality of standardized logs of a plurality of device ids, determine whether each standardized log has an error, and output an error category if there is an error. In the method, the previous-event id of each device id is recorded firstly, and for a new device id, the previous-event id is null. Then in the method, all standardized logs are sorted in the order of the occurrence time from small to large and the event id from small to large, and grouped according to the device id, such that those of the same device id are grouped into one group. Finally, each group is traversed to determine whether the standardized logs in each group are incorrect.

Further, in some embodiments, determining by the server of whether the standardized logs in each group are incorrect specifically includes:
acquiring the device id, the startup id and the event id of each standardized log in the group;
when the device id, the startup id or the event id is invalid, determining that the standardized log is incorrect;
when the device id, the startup id and the event id are valid, calculating a range of a next-event id according to the previous-event id of the device id;
when the event id is within the range of the next-event id, determining that the standardized log is correct, and setting a present-event id as the previous-event id of the device id;
when the event id is not within the range of the next-event id, determining that the standardized log is incorrect.

In this embodiment, in the method, it is determined sequentially whether each standardized log in each group is incorrect. Firstly, the device id, the startup id and the event id of the standardized log are acquired, and then whether the device id is invalid can be determined according to a device id rule, whether the startup id is invalid can be determined according to a startup id rule, and whether the event id is invalid can be determined according to an event id rule.

The device id rule may include that: there are more than 32 bits; there are less than 32 bits; symbols contain characters other than hexadecimal character strings (digits of 0-9 and letters of a-f), etc. For example, if a device id is 3a55d95595a6f9e37dee53826b4daff20, the device id is invalid because there are more than 32 bits; if a device id is 3a55d95595a6f9e37dee53826b4daff, the device id is invalid because there are less than 32 bits; if a device id is 3a55d95595a6f9e37dee53826b4dafg, the device id is invalid because symbols contain the letter g.

The startup id rule may include that: the device ids are inconsistent; the first character string has more than 8 bits; the first character string has less than 8 bits; the first character string contains a non-digit, etc. For example, if a device id is 3a55d95595a6f9e37dee53826b4daff3 and a startup id is 3a55d95595a6f9e37dee53826b4daff2-00000080, the startup id is invalid because the device ids are inconsistent. If a device id is 3a55d95595a6f9e37dee53826b4daff2 and a startup id is 3a55d95595a6f9e37dee53826b4daff2-000000080, the startup id is invalid because the first character string has more than 8 bits. If a device id is 3a55d95595a6f9e37dee53826b4daff2 and a startup id is 3a55d95595a6f9e37dee53826b4daff2-0000080, the startup id is invalid because the first character string has less than 8 bits. If a device id is 3a55d95595a6f9e37dee53826b4daff2 and a startup id is 3a55d95595a6f9e37dee53826b4daff2-0000008a, the startup id is invalid because the first character string contains the letter a.

The event id rule may include that: the device ids inconsistent; the second character string has more than 10 bits; the second character string has less than 10 bits; the second character string contains a non-digit, invalid ending, etc. For example, if a device id is 3a55d95595a6f9e37dee53826b4daff4, a startup id is 3a55d95595a6f9e37dee53826b4daff3-00000080 and an event id is 3a55d95595a6f9e37dee53826b4daff2-00000080-0000000009, the event id is invalid because the device ids are inconsistent. If a device id is 3a55d95595a6f9e37dee53826b4daff2, a startup id is 3a55d95595a6f9e37dee53826b4daff2-00000080 and an event id is 3a55d95595a6f9e37dee53826b4daff2-00000080-00000000090, the event id is invalid because the second character string has more than 10 bits. If a device id is 3a55d95595a6f9e37dee53826b4daff2, a startup id is 3a55d95595a6f9e37dee53826b4daff2-00000080 and an event id is 3a55d95595a6f9e37dee53826b4daff2-00000080-000000009, the event id is invalid because the second character string has less than 10 bits. If a device id is 3a55d95595a6f9e37dee53826b4daff2, a startup id is 3a55d95595a6f9e37dee53826b4daff2-00000080 and an event id is 3a55d95595a6f9e37dee53826b4daff2-00000080-000000009a, the event id is invalid because the second character string contains the letter a. If a device id is 3a55d95595a6f9e37dee53826b4daff2, a startup id is 3a55d95595a6f9e37dee53826b4daff2-00000080 and an event id is 3a55d95595a6f9e37dee53826b4daff2-00000080-0000000009-f, the event id is invalid because ending with −f is invalid.

In this embodiment, if the device id, the startup id or the event id is invalid, it is determined that the standardized log is incorrect, and the error category thereof is an invalid device id, an invalid startup id or an invalid event id. If the device id, the startup id and the event id are valid, the range of the next-event id is calculated according to the previous-event id of the device id. When the event id is within the range of the next-event id, it is determined that the standardized log is correct, and a value of the present-event id is used to set the previous-event id of the device id so as to perform a next determination. For example, in this determination, a value of the previous-event id of the device id is 3, and a value of the present-event id of the device id is 4. The server calculates the range of the next-event id according to the previous-event id (with the value of 3) and determines whether the present-event id (with the value of 4) is within the range of the next-event id. In this example, the server determines that the present-event id (with the value of 4) is within the range of the next-event id, and then this determination is finished. At this time, in order to facilitate the next determination, the value of 4 (i.e., the value of the present-event id) is used to set the previous-event id. That is, in the next determination, the value of the previous-event id of the device id is 4. If a value of the present-event id of the device id is 5, the server calculates the range of the next-event id according to the previous-event id (with the value of 4 now), and determines that the present-event id (with the value of 5 now) is within the range of the next-event id. When the event id is not within the range of the next-event id, it is determined that the standardized log is incorrect.

Further, in some embodiments, calculating of the range of the next-event id according to the previous-event id of the device id specifically includes:
when the previous-event id of the device id does not exist, the first character string and the second character string of the event id are 1 and the begin-end flag identifies the beginning event in the range of the next-event id;
when the previous-event id of the device id is the beginning event or the intermediate event, the range of the next-event id includes two event ids, and second character strings of the two event ids are both increased by 1, where the begin-end flag of one event id identifies the intermediate event, and the begin-end flag of the other event id identifies the end event;
when the previous-event id of the device id is the end event, the first character string and the second character string of the event id are both increased by 1 and the begin-end flag identifies the beginning event in the range of the next-event id.

In this embodiment, the range of the next-event id may be calculated and obtained according to the orderliness of the standardized log. If the previous-event id of the device id does not exist, in the range of the next-event id, the first character string and the second character string of the event id are 1, and the begin-end flag identifies the beginning event. For example, a range of the next-event id=[device id-00000001-0000000001-b]. If the previous-event id of the device id is the beginning event or the intermediate event, the range of the next-event id includes two event ids, and second character strings of the two event ids are both increased by 1, where the begin-end flag of one event id identifies the intermediate event, and the begin-end flag of the other event id identifies the end event. For example, a range of the next-event id=[startup id-second character string+1, startup id-second character string+1-e]. If the previous-event id of the device id is the end event, in the range of the next-event id, the first character string and the second character string of the event id are both increased by 1, and the begin-end flag identifies the beginning event. For example, a range of the next-event id=[startup id+1-second character string+1-b].

Further, in some embodiments, after determining that the standardized log is incorrect, the method further includes:
determining an error category of the standardized log; where, the error category is a first-time event missing when the previous-event id of the device id does not exist;
the error category is an event repetition when the previous-event id of the device id is equal to the present-event id;
the error category is an event disorder when the previous-event id of the device id is greater than the present-event id;
the error category is an event missing when the previous-event id of the device id is smaller than the present-event id.

In this embodiment, the error category includes several types. (1) The previous-event id of the device id does not exist, and the error category is the first-time event missing. (2) The previous-event id of the device id is equal to the present-event id, and the error category is the event repetition. For example, if the previous-event id is the end event, the error category is an end event repetition, and if the previous-event id is the beginning event, the error category is a beginning event repetition. (3) The previous-event id of the device id is greater than the present-event id, and the error category is the event disorder. (4) The previous-event id of the device id is smaller than the present-event id and a difference value between the present-event id and the previous-event id of the device id is greater than 1, the error category is the event missing, and the previous-event id is set with the event id of the present event. For example, if the range of the next-event id contains only one beginning event, the error category is the beginning event missing, and if the range of the next-event id contains only one end event, the error category is the end event missing.

Further, in some embodiments, the method further includes:
when receiving a filtering instruction including the device id or the startup id, the server obtains logs related to the application by filtering according to the device id, or obtains logs related to one startup of the application by filtering according to the startup id.

In this embodiment, in the log supervision method, after adding the device id, the startup id and the event id, the obtained standardized log has filterability. For example, logs related to only the application may be obtained by filtering with the device id, and logs related to only a certain startup may be obtained by filtering with the startup id.

A high-accuracy log supervision system includes a mobile terminal and a server;
where the mobile terminal is configured to: acquire a log generated by an application, and add a device id, a startup id and an event id to the log to obtain a standardized log, where the device id is used for uniquely identifying the mobile terminal, the startup id is used for identifying a number of times of startup of the application after the application is installed, and the event id is used for identifying a number of times of event occurrence of the application after the application is installed; and send the standardized log to the server;
the server is configured to summarize all standardized logs from different mobile terminals and determine whether the standardized logs are incorrect.

For brief description of the system provided by the embodiment of the present disclosure, the parts that are not mentioned in the embodiment may be found in the corresponding contents in the foregoing embodiments.

Finally, it should be noted that the foregoing embodiments are merely used for illustrating the technical solutions of the present disclosure, but not intended to limit them. Although the present disclosure is illustrated in detail with reference to the foregoing embodiments, those skilled in the art should understand that they may still make modifications to the technical solutions described in the foregoing embodiments, or make equivalent replacements to some or all technical features thereof. These modifications or replacements do not make the essence of the corresponding technical solutions depart from the scope of the technical solutions of embodiments of the present disclosure, and shall all belong to the scope of the claims and specification of the present disclosure.

What is claimed is:

1. A log supervision method, comprising:
acquiring, by a mobile terminal, a log generated by an application;
adding, by the mobile terminal, a device id, a startup id and an event id to the log to obtain a standardized log; wherein the device id is used for uniquely identifying the mobile terminal; the startup id is used for identifying a number of times of startup of the application after the application is installed; the event id is used for identifying a number of times of event occurrence of the application after the application is installed;
sending, by the mobile terminal, the standardized log to a server;
summarizing, by the server, all standardized logs from different mobile terminals, and determining, by the server, whether the standardized logs are incorrect.

2. The log supervision method according to claim 1, wherein,
the device id is obtained by performing a Hash operation on a mobile terminal id of the mobile terminal.

3. The log supervision method according to claim 2, wherein,
the startup id comprises the device id and a first character string; every time the application is started, the first character string is increased by 1; the first character string is initialized to 1, and is set to 1 after overflow.

4. The log supervision method according to claim 3, wherein,
the event id comprises the startup id, a second character string and a begin-end flag; every time an event of the application occurs, the second character string is increased by 1; the second character string is initialized to 1, and is set to 1 after overflow; the begin-end flag is used for identifying a beginning event, an intermediate event or an end event.

5. The log supervision method according to claim 4, wherein determining, by the server, whether the standardized logs are incorrect specifically comprises:
recording, by the server, a previous-event id of each device id;
sorting, by the server, all standardized logs in an order of an occurrence time from small to large and the event id from small to large, and grouping, by the server, all standardized logs according to the device id;
traversing, by the server, each group, and determining, by the server, whether standardized logs in each group are incorrect.

6. The log supervision method according to claim 5, wherein,
determining, by the server, whether the standardized logs in each group are incorrect specifically comprises:
acquiring the device id, the startup id and the event id of each standardized log in the group;
when the device id, the startup id or the event id is invalid, determining that the standardized log is incorrect;
when the device id, the startup id and the event id are valid, calculating a range of a next-event id according to the previous-event id of the device id;
when the event id is within the range of the next-event id, determining that the standardized log is correct;
when the event id is not within the range of the next-event id, determining that the standardized log is incorrect.

7. The log supervision method according to claim 6, wherein calculating the range of the next-event id according to the previous-event id of the device id specifically comprises:
when the previous-event id of the device id does not exist, setting the first character string and the second character string of the event id to be 1 and setting the begin-end flag to identify the beginning event in the range of the next-event id;
when the previous-event id of the device id is the beginning event or the intermediate event, increasing both of second character strings of two event ids comprised in the range of the next-event id by 1, wherein the begin-end flag of one of the two event ids identifies the intermediate event, and the begin-end flag of the other one of the two event ids identifies the end event;
when the previous-event id of the device id is the end event, increasing both of the first character string and the second character string of the event id by 1 and setting the begin-end flag to identify the beginning event in the range of the next-event id.

8. The log supervision method according to claim 6, after determining that the standardized log is incorrect, further comprising:
determining an error category of the standardized log; wherein,
the error category is a first-time event missing when the previous-event id of the device id does not exist;
the error category is an event repetition when the previous-event id of the device id is equal to the present-event id;
the error category is an event disorder when the previous-event id of the device id is greater than the present-event id;
the error category is an event missing when the previous-event id of the device id is smaller than the present-event id and a difference value between the present-event id and the previous-event id of the device id is greater than 1.

9. The log supervision method according to claim 1, further comprising:
when receiving a filtering instruction comprising the device id or the startup id, obtaining, by the server, logs related to the application by filtering according to the device id, or obtaining, by the server, logs related to one startup of the application by filtering according to the startup id.

10. A log supervision system, comprising a mobile terminal and a server;
wherein the mobile terminal is configured to: acquire a log generated by an application, and add a device id, a startup id and an event id to the log to obtain a standardized log, wherein the device id is used for uniquely identifying the mobile terminal, the startup id is used for identifying a number of times of startup of the application after the application is installed, and the event id is used for identifying a number of times of event occurrence of the application after the application is installed; and send the standardized log to the server;
the server is configured to summarize all standardized logs from different mobile terminals and determine whether the standardized logs are incorrect.

11. The log supervision system according to claim 10, wherein,
the device id is obtained by performing a Hash operation on a mobile terminal id of the mobile terminal.

12. The log supervision system according to claim 11, wherein,
the startup id comprises the device id and a first character string; every time the application is started, the first character string is increased by 1; the first character string is initialized to 1, and is set to 1 after overflow.

13. The log supervision system according to claim 12, wherein,
the event id comprises the startup id, a second character string and a begin-end flag; every time an event of the application occurs, the second character string is increased by 1; the second character string is initialized to 1, and is set to 1 after overflow; the begin-end flag is used for identifying a beginning event, an intermediate event or an end event.

14. The log supervision system according to claim 13, wherein the server is further configured to:
record a previous-event id of each device id;
sort all standardized logs in an order of an occurrence time from small to large and the event id from small to large, and group all standardized logs according to the device id;
traverse each group, and determine whether standardized logs in each group are incorrect.

15. The log supervision system according to claim 14, wherein the server is further configured to:
acquire the device id, the startup id and the event id of each standardized log in the group;
when the device id, the startup id or the event id is invalid, determine that the standardized log is incorrect;
when the device id, the startup id and the event id are valid, calculate a range of a next-event id according to the previous-event id of the device id;
when the event id is within the range of the next-event id, determine that the standardized log is correct;
when the event id is not within the range of the next-event id, determine that the standardized log is incorrect.

16. The log supervision system according to claim 15, wherein the server is further configured to:
when the previous-event id of the device id does not exist, set the first character string and the second character string of the event id to be 1 and set the begin-end flag to identify the beginning event in the range of the next-event id;
when the previous-event id of the device id is the beginning event or the intermediate event, increasing both of second character strings of two event ids comprised in the range of the next-event id by 1, wherein the begin-end flag of one of the two event ids identifies the intermediate event, and the begin-end flag of the other one of the two event ids identifies the end event;
when the previous-event id of the device id is the end event, increasing both of the first character string and the second character string of the event id by 1 and setting the begin-end flag to identify the beginning event in the range of the next-event id.

17. The log supervision system according to claim 15, wherein after the server determines that the standardized log is correct, the server is further configured to determine an error category of the standardized log; wherein,
the error category is a first-time event missing when the previous-event id of the device id does not exist;
the error category is an event repetition when the previous-event id of the device id is equal to the present-event id;
the error category is an event disorder when the previous-event id of the device id is greater than the present-event id;
the error category is an event missing when the previous-event id of the device id is smaller than the present-event id and a difference value between the present-event id and the previous-event id of the device id is greater than 1.

18. The log supervision system according to claim 10, wherein the server is further configured to:
when receiving a filtering instruction comprising the device id or the startup id, obtain logs related to the application by filtering according to the device id, or obtain logs related to one startup of the application by filtering according to the startup id.
